(19) United States
(12) Patent Application Publication
(10) Pub. No.: US 2009/0292872 A1
(43) Pub. Date: Nov. 26, 2009

(54) Method and device for controlling disk array apparatus

(75) Inventor: Mitsuhiko Ohta, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,530

(22) Filed: Jan. 28, 2009

(30) Foreign Application Priority Data
May 21, 2008 (JP) 2008-133538

(51) Int. Cl. G06F 12/00

(52) U.S. Cl. 711/114; 711/E12.001

(57) ABSTRACT

A method for controlling a disk array apparatus includes: assigning serial addresses to all addresses of multiple disk drives of the disk array apparatus in an order of disk drive; equally separating the serial addresses into a first disk group having first serial addresses in an increasing order and a second disk group having second serial addresses in the increasing order; and writing data in the first disk group at one of the first serial addresses and in the second disk group at a corresponding one of the second serial addresses, said corresponding one of the second serial addresses being obtained by adding a maximum serial address out of the first serial addresses of the first disk group to said one of the first serial addresses.

### CROSS-REFERENCE TO RELATED APPLICATION

This application is based upon and claims the benefit of priority of the prior Japanese Patent Application No. 2008-133538, filed on May 21, 2008, the entire contents of which are incorporated herein by reference.

### FIELD

The present invention generally relates to methods and devices for controlling a disk array apparatus, and more particularly, to a method and a device for controlling a disk array apparatus equipped with multiple disk drives.

### BACKGROUND

Information processing apparatus such as computers stores data in a secondary storage device. Generally, a non-volatile recording medium may be used for the secondary storage device, and is typically a hard disk drive (HDD). The HDD stores data on a rapidly rotating magnetic recording medium (magnetic disk) at a high density. The HDD is composed of precision mechanical parts and an electronic circuit. It is thus impossible to reduce the possibility of failure to zero.

RAID (Redundant Array of Inexpensive Disks) uses multiple HDDs having relatively small capacities arranged in a redundant way in order to avoid loss of data due to the failure of a disk or disks. There are several RAID levels such as RAID1, RAID5, RAID6 and RAID10.

RAID1 is called mirroring and writes data to multiple disks (for example, two disks) simultaneously. Even if one of the disks becomes faulty, data can be read from the remaining disk or disks. Thus, the entire system continues to work even after the disk failure (see Japanese Patent Application Publication No. 2000-298556).

RAID1 principally uses two HDDs having an identical capacity in terms of data duplexing. When an even number of HDDs (four, six or more) is used to obtain a large capacity, HDDs are grouped every two HDDs and are associated for mirroring on the group basis.

As described above, RAID1 has a limitation on data duplexing and needs an even number of HDDs. When an odd number of HDDs is prepared, one HDD is not involved in mirroring. Thus, the entire capacity cannot be utilized efficiently.

The above-described Publication discloses a mirroring method in which three HDDs are divided into seven virtual disks, and six disks among the seven disks are involved in mirroring (see paragraphs 0027 and 0028). However, there may be an unused virtual disk as depicted in FIG. 9 of the Publication. Thus, improvement directed to the efficient use of the entire capacity is insufficient.

### SUMMARY

According to an aspect of the present invention, there is provided a method for controlling a disk array apparatus including: assigning serial addresses to all addresses of multiple disk drives of the disk array apparatus in an order of disk drive; equally separating the serial addresses into a first disk group having first serial addresses in an increasing order and a second disk group having second serial addresses in the increasing order; and writing data in the first disk group at one of the first serial addresses and in the second disk group at a corresponding one of the second serial addresses, said corresponding one of the second serial addresses being obtained by adding a maximum serial address out of the first serial addresses of the first disk group to said one of the first serial addresses.

### BRIEF DESCRIPTION OF THE DRAWINGS

FIG. 1 is a block diagram of a RAID controller in accordance with an embodiment of the present invention;

FIG. 2 is a block diagram of a disk controller depicted in FIG. 1;

FIGS. 3A and 3B show an exemplary configuration of RAID1 in a case where the disk array apparatus has three HDDs;

FIGS. 4A and 4B show an exemplary configuration of RAID1 in a case where the disk array apparatus has four HDDs;

FIGS. 5A and 5B show an exemplary configuration of RAID1 in a case where the disk array apparatus has N HDDs; and

FIG. 6 is a flowchart of a sequence of a data storage process of the disk controller.

### DESCRIPTION OF EMBODIMENTS

A description will now be given, with reference to the accompanying drawings, of a device for controlling a disk array apparatus in accordance with an embodiment of the present invention.

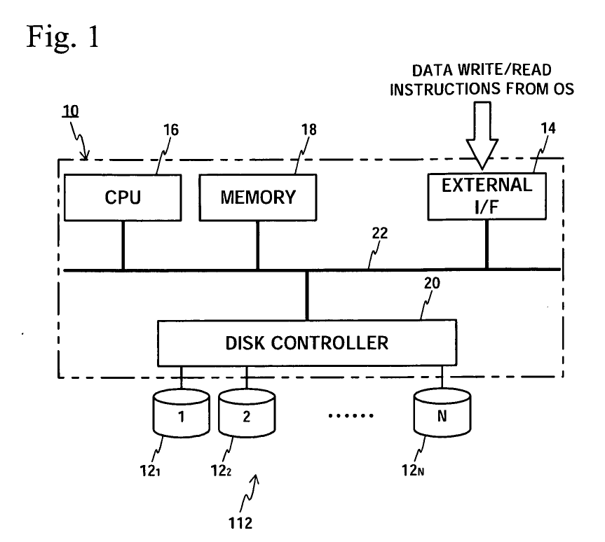

Referring to FIG. 1, a RAID controller 10 according to an embodiment of the present invention realizes data duplexing (RAID1) using a disk array apparatus 112 having N HDDs, namely, HDDs 12₁ through 12_{N} where N is a natural number equal to or greater than 2. The RAID controller 10 has a connector that is connectable to a PCI (Peripheral components Interconnect) connector of a main body of a personal computer (PC). The connector of the RAID controller 10 is detachably connected to the PCI connector of the PC main body.

The RAID controller 10 has an external interface (I/F) unit 14, a central processing unit (CPU) 16, a memory 18, a disk controller 20 and an internal bus 22, which functions as a transmission path for connecting the above structural elements.

The external I/F unit 14 is used to connect the RAID controller 10 to a bus of the PC main body such as a PCI bus. The RAID controller 10 is supplied, through the external I/F unit 14, with data read/write instructions and address information on data to be read from or written into the HDDs 12₁ through 12_{N} from the operation system (OS) of the PC.

The CPU 16 controls the entire RAID controller 10, and is involved in data transfers between the structural elements and operation controls thereof through the internal bus 22. Responsive to instructions from the OS, the CPU 16 sends the disk controller 20 instructions about a process (data read/write) to be executed. The memory 18 includes memories such as a read only memory and a random access memory. The read only memory may store firmware and various parameters necessary for operations of the RAID controller 10. The random access memory may be a work area for realizing high-speed data reading/writing in execution of operations by the CPU 16.

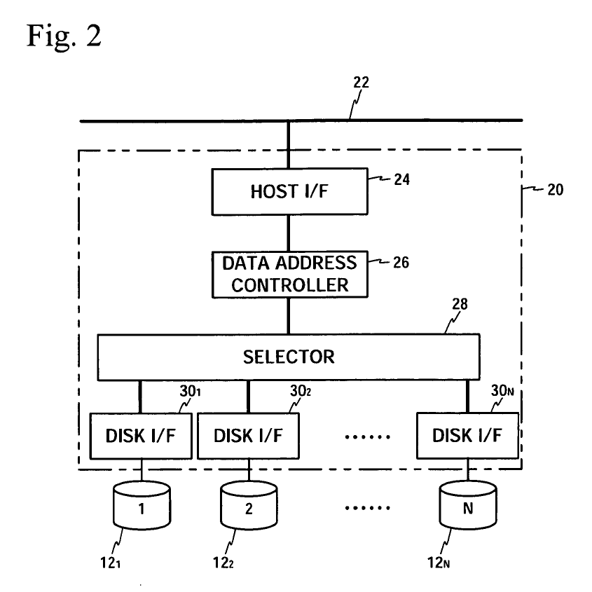

The disk controller 20 specifies target HDDs from among the HDDs 12₁ through 12_{N} and addresses, and executes a read/write operation on storage areas in the target HDDs specified by the addresses. More specifically, as depicted in FIG. 2, the disk controller 20 includes a host I/F unit 24, a data address controller 26, a selector 28 and N disk I/F units 30₁ through 30_{N}.

The host I/F unit 24 receives instructions supplied from the OS via the external I/F unit 14, the CPU 16 and the internal bus 22, and outputs the received instructions to the data address controller 26. The data address controller 26 equally divides the whole data storage capacity of all the HDDs 12₁ through 12_{N} into two disk groups in an increasing order of the serial addresses, and specifies the target HDDs and addresses involved in data writing/reading to be executed. A detailed operation of the data address controller 26 will be described later. The selector 28 selects the target HDDs from among the HDDs 12₁ through 12_{N} specified by the data address controller 26 via the corresponding I/F units among the I/F units 30₁ through 30_{N}.

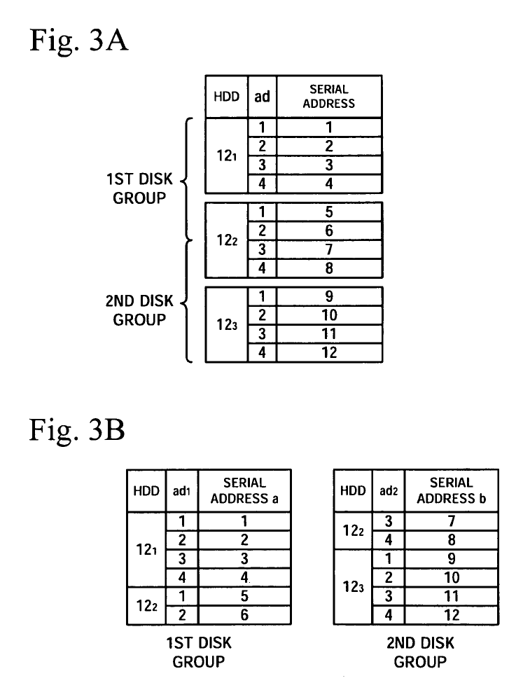

The detailed operations of the data address controller 26 and the selector 28 will now be described with reference to FIGS. 3A through 5B.

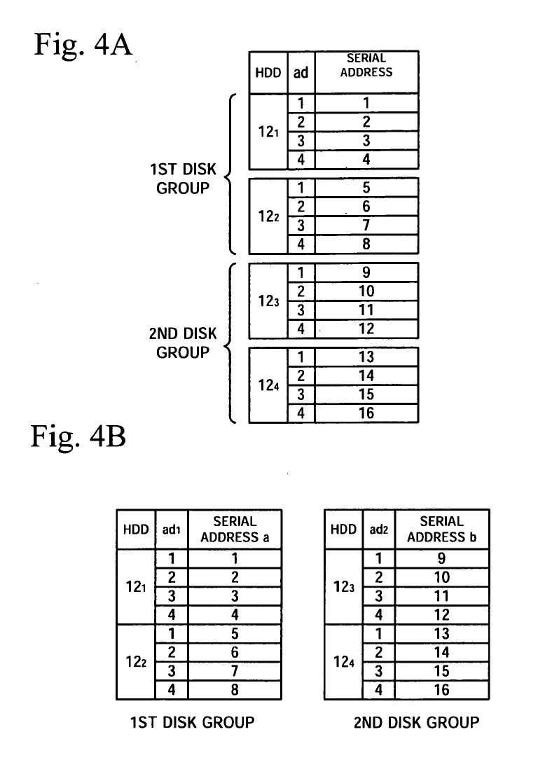

First, grouping and data writing for realizing RAID1 by the data address controller 26 is described with reference to FIGS. 3A, 3B, 4A and 4B. FIGS. 3A and 3B depict an exemplary configuration in which the disk array apparatus 112 has three HDDs (12₁-12₃), and FIGS. 4A and 4B depict an exemplary configuration in which the disk array apparatus 112 has four HDDs (12₁-12₄).

Configuration with Three HDDs (FIGS. 3A and 3B):

In this configuration, the data address controller 26 assigns new addresses 1 through 12 to all of addresses ad of each of all the HDDs 12₁ through 12₃ in which “address ad” denotes a chunk size composed of a given number of sectors. It is assumed that each of the HDDs 12₁ through 12₃ has four chunks. The new addresses 1 through 12 are referred to as serial addresses, and are assigned in the order of HDD12₁, HDD12₂ and HDD12₃ (the order of hard disk drive).

Next, the data address controller 26 equally separates the serial addresses into two groups. This is called grouping. A first disk group is composed of serial addresses 1 through 6, and a second disk group is composed of serial addresses 7 through 12. Preferably, the chunk size is determined so that the total of the chunk addresses is an even number since the serial addresses are equally separated into two groups, as described above.

When the data address controller 26 receives a write instruction sent from the OS via the host I/F unit 24 and the CPU 16, the data address controller 26 identifies (extracts) the serial addresses a (a=1−6) of the first disk group from the received write instruction.

The data address controller 26 specifies the serial addresses b (b=7−12) of the second disk group that respectively correspond to the serial addresses a (a=1−6) of the first disk group. The serial addresses a and the corresponding serial addresses b are adjacent to each other in the horizontal direction in FIG. 3B, and have identical positions in the vertical direction. More particularly, serial address “1” of the first disk group corresponds to serial address “7” of the second group, and serial address “2” of the first disk group corresponds to serial address “8” of the second group. Similarly, serial address “6” of the first disk group corresponds to serial address “12” of the second disk group. That is, the serial addresses a and b have a relation defined by expression (1):

b=a+aₘₐₓ (1)

where aₘₐₓ is the maximum address of the first disk group.

The data address controller 26 obtains the corresponding serial addresses b of the second disk group by applying the serial addresses a of the first disk group specified by the OS to expression (1). The data address controller 26 instructs the selector 28 to select one HDD specified by the serial address a of the first disk group and one HDD specified by the corresponding serial address b of the second disk group, so that identical data can be written into storage areas of the two specified HDDs. In practice, the selector 28 may be supplied with instructions identifying one of the HDDs 12₁ through 12₃ and the address ad of the HDD specified by the serial address a and one of the HDDs 12₁ through 12₃ and the address ad of the HDD specified by the corresponding serial address b. This identification will be described later.

Configuration with Four HDDs (FIGS. 4A and 4B):

The above-described process applied to the configuration with the three HDDs may be applied to a configuration with four HDDs 12₁ through 12₄ as depicted in FIG. 4A. More particularly, the data address controller 26 assigns serial addresses (1 to 16) to all the addresses (1 to 4) of each of all the HDDs 12₁ through 12₄, as depicted in FIG. 4A. This assignment is carried out in the order of HDD 12₁, HDD 12₂, HDD 12₃ and HDD 12₄ (the order of hard disk drive). Next, the data address controller 26 equally separates the serial addresses into the two groups (grouping), as depicted in FIG. 4B. Serial addresses 1 through 8 form a first disk group, and serial addresses 9 through 16 form a second disk group. Thus, the HDDs 12₁ and 12₂ belong to the first disk group, and HDDs 12₃ and 12₄ belong to the second disk group.

In FIG. 4B, serial address “1” of the first disk group corresponds to serial address “9” in the second disk group, and serial address “2” of the first disk group corresponds to serial address “10” of the second disk group. Similarly, serial address “8” of the first group corresponds to serial address “16” of the second disk group. That is, the serial addresses a and b have the same relation as defined in expression (1) described before.

The data address controller 26 obtains the corresponding serial addresses b of the second disk group by applying the serial addresses a of the first disk group specified by the OS to expression (1). The data address controller 26 instructs the selector 28 to select one HDD specified by the serial address a of the first disk group and one HDD specified by the corresponding serial address b of the second disk group, so that identical data can be written into storage areas of the two specified HDDs.

As described above, the present embodiment is capable of equally separating the serial addresses into two disk groups irrespective of whether the system has an odd number of HDDs (three HDDs in the exemplary configuration) or an even number of HDDs (four HDDs in the exemplary configuration). One of the two groups of HDDs may be used as a primary group and the other group may be used as a secondary group so that data duplexing or mirroring can be realized.

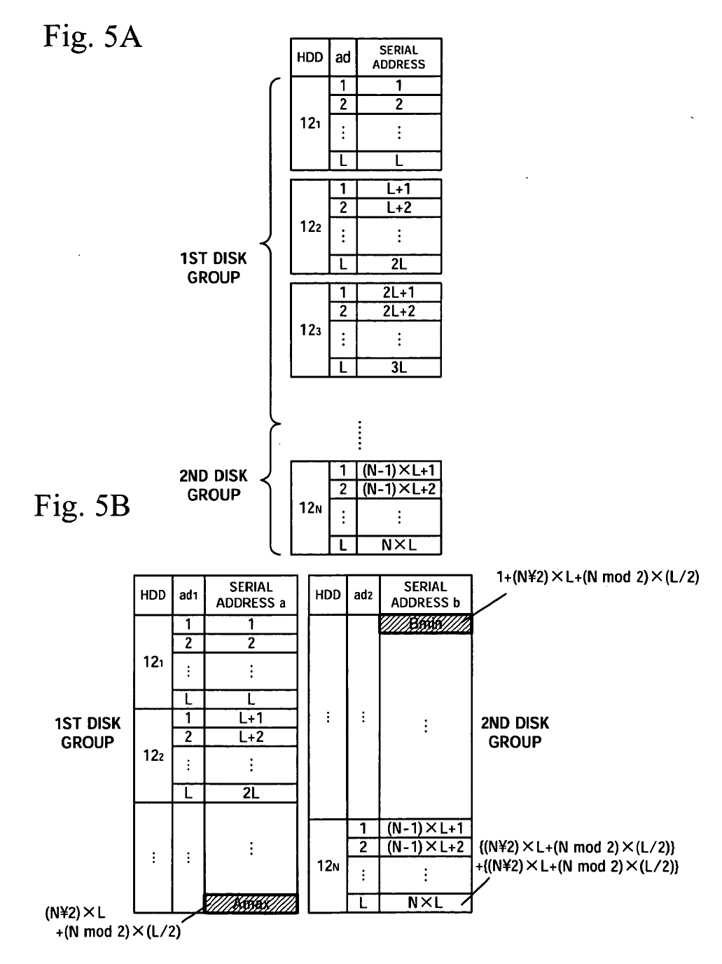

A description will now be given, with reference to FIGS. 5A and 5B, of an exemplary configuration obtained by generalizing the exemplary configurations as depicted in FIGS. 3A, 3B, 4A and 4B. In FIGS. 5A and 5B, it is assumed that a system has N HDDs (12₁-12_{N}) and the maximum address of each HDD is L. Like the configurations depicted in FIGS. 3A, 3B, 4A and 4B, all the addresses ad (ad=1 to L) are assigned serial addresses, which are equally separated into two groups consisting of a first disk group and a second disk group. The maximum serial address Amax of the first disk group (see FIG. 5B) can be obtained by expression (2):

Amax=(N¥2)×L+(Nmod2)×(L/2) (2)

Where “¥2” denotes a quotient of truncating division by 2 in which the remainder is discarded (integer division by 2), and “mod2” denotes the remainder (remainder operation).

The minimum address Bmin of the second disk group is the serial address next to Amax (obtained by adding 1 to Amax), and is thus described by expression (3):

Bmin=1+(N¥2)×L+(Nmod2)×(L/2) (3)

The maximum serial address (N×L) of the second disk group is described by expression (4):

(N×L)={(N¥2)×L+(Nmod2)×(L/2)}+{(N¥2)×L+(Nmod2)×(L/2)} (4)

As described above, the serial addresses a of the first disk group and the serial addresses b of the second disk group (horizontally adjacent serial addresses in FIG. 5B) have a relation similar to that described by expression (1). More particularly, this relation is described by expression (5):

b=a+{(N¥2)×L+(Nmod2)×(L/2)} (5)

where a is equal to or smaller than {(N¥2)×L+(Nmod2)×(L/2)}.

Thus, the data address controller 26 obtains the corresponding serial address b of the second disk group by applying the serial address a of the first disk group specified by the OS to expression (5). The data address controller 26 instructs the selector 28 to select one HDD specified by the serial address a of the first disk group and one HDD specified by the corresponding serial address b of the second disk group, so that identical data can be written into storage areas of the two specified HDDs.

It can be seen from expression (5) that the operation necessary for generating the serial address b needs the integer division (¥2), remainder operation (mod2) and fixed value multiplication (×L). The integer division by 2 may be implemented by shifting bits rightwards, and the remainder operation may be implemented by extracting the least significant bit (LSB). Thus, expression (5) may be computed by light processing.

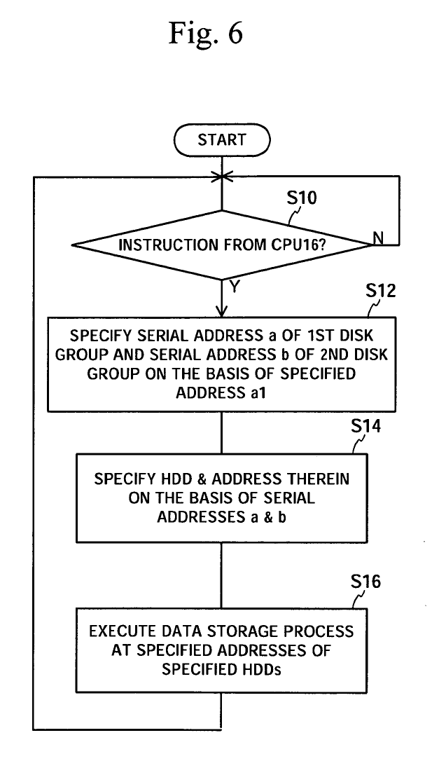

A description will now be given, with reference to a flowchart of FIG. 6, of a data storage sequence by the disk controller 20 in connection with the generalized example shown in FIGS. 5A and 5B.

The sequence commences with step S10 at which the data address controller 26 of the disk controller 20 is in the standby state until receiving an instruction from the CPU 16. When the answer of step S10 becomes YES, the data address controller 26 specifies an address for each disk group at which data should be stored. The address for each disk group may be the serial address a for the first disk group and the serial address b for the second disk group.

Assuming that OS specifies “a₁” as the serial address of the first disk group in the data storage instruction, the data address controller 26 computes the corresponding serial address b of the second disk group by using expression (5) as follows:

b=a₁+{(N¥2)×L+(Nmod2)×(L/2)}.

At step S14, the data address controller 26 specifies the HDD (12ₙ₁) having the specified serial address a (=a₁) and the address (ad₁) in the specified HDD (12ₙ₁) corresponding to the above serial address a (=a₁). For example, in FIGS. 5A and 5B, for a serial address of (L+2), the data address controller 26 specifies one HDD (here HDD 12₂) and one address (here ad₁=2) identified by the serial address (L+2). Similarly, the data address controller 26 specifies the HDD (12ₙ₂) having the serial address b and the address (ad₂) in the specified HDD (12ₙ₂) corresponding to the above serial address b.

In the above specifying process, the data address controller 26 obtains n₁, ad₁, n₂ and ad₂ by the following expressions (6), (7), (8) and (9), respectively:

n₁=((a₁−1)¥L)+1 (6)

ad₁=((a₁ modL) (7)

n₂=((b−1)¥L)+1 (8)

ad₂=(b modL) (9)

The data address controller 26 instructs the selector 28 to select the HDD12ₙ₁ and the address ad₁ specified by expressions (6) and (7) and to select the HDD 12ₙ₂ and the address ad₂ specified by expressions (8) and (9), so that data can be written into the corresponding storage areas and duplexing of data (mirroring) can be realized.

According to the present embodiment, even if any of the HDDs becomes faulty and data cannot be read therefrom, desired data can be read from the other disk group associated with the faulty HDD. More particularly, if data to be read is stored in the storage area specified by the serial address a of the first disk group and cannot be read therefrom, the data address controller 26 computes the corresponding serial address b using expression (5) and data stored therein can be read. Thus, the disk array apparatus 112 can continue to work.

The data duplexing algorithm of the present embodiment may be extended so that data is read from both the first and second disk groups. This extension speeds up data reading.

According to the present embodiment, the data address controller 26 executes the steps of assigning serial addresses (1-N×L) to all addresses (1 to L) of N disk drives (12₁-12_{N}) of the disk array apparatus 112 in an order of disk drive; equally separating the serial addresses into the first disk group having first serial addresses in the increasing order and the second disk group having second serial addresses in the increasing order; and writing data in the first disk group at one of the first serial addresses and in the second disk group at a corresponding one of the second serial addresses obtained by adding the maximum serial address (Amax) of the first serial addresses to the above-described one of the first serial addresses. It is thus possible to efficiently utilize the data capacity of the N disk drives of the disk array apparatus 112 and realize data duplexing (mirroring).

According to the present embodiment, the serial addresses of the first disk group and those of the second disk group are associated with each other only by the maximum serial address of the first disk group. It is thus possible to easily associate the serial addresses of the first and second disk groups with each other. The present embodiment employs additional computation of expression (5) resulting from the serial addresses. However, the operation necessary for generating the serial addresses b needs the integer division (¥2), remainder operation (mod2) and fixed value multiplication (×L), and is thus simple. Thus the computation of expression (5) hardly increases the load on the RAID controller 10.

According to the present embodiment, the serial addresses are assigned sequentially and are equally separated into the two groups in the increasing order. Thus, there is no possibility that two addresses for mirroring are associated in the identical HDD and data duplexing is configured therein. The present embodiment is capable of reliably realizing mirroring (RAID1).

According to the present embodiment, almost all of the total capacity may be used to form mirroring irrespective of whether the number of HDDs is even or odd. Even when the total capacity is not completely used, only a small amount of capacity equal to one address (LBA (Logical Block Addressing) or chunk) remains. It is thus possible to efficiently use the storage capacity of the disk array apparatus 112 for mirroring.

The RAID controller 10 is not limited to the hardware configuration but may be implemented by software in which the OS controls the HDDs through a drive controller (SCSI: Small Computer System Interface).

The above-described embodiment is not limited to the above-mentioned chunk size but may employ another size, which may be based on, for example, LBA.

In the foregoing, each HDD has the identical maximum address (L) for the sake of simplicity. However, the present invention is not limited to the above. That is, different HDDs have different maximum addresses in terms of equally separating the serial addresses into the two groups. In this case, identical data are written in HDDs at the serial address a of the first disk group and the serial address b of the second disk group obtained by adding the maximum address of the first disk group to the serial address a. It is thus possible to realize efficient mirroring as in the case of the first embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A method for controlling a disk array apparatus comprising:
assigning serial addresses to all addresses of multiple disk drives of the disk array apparatus in an order of disk drive;
equally separating the serial addresses into a first disk group having first serial addresses in an increasing order and a second disk group having second serial addresses in the increasing order; and
writing data in the first disk group at one of the first serial addresses and in the second disk group at a corresponding one of the second serial addresses, said corresponding one of the second serial addresses being obtained by adding a maximum serial address out of the first serial addresses of the first disk group to said one of the first serial addresses.

2. The method as claimed in claim 1, wherein in a case where the disk array apparatus N disk drives (N is a natural number equal to or greater than 2) and a maximum address of each of the disk drives is L, the maximum serial address of the first disk group is now labeled Amax and is described as follows:
Amax=(N¥2)×L+(Nmod2)×(L/2)
where ¥2 denotes a quotient of integer division by 2, and mod2 denotes a remainder.

3. The method as claimed in claim 1, wherein the disk array apparatus has an odd number of disk drives as the multiple disk drives.

4. The method as claimed in claim 2, wherein the disk array apparatus has an odd number of disk drives as the multiple disk drives.

5. A device for controlling a disk array apparatus comprising:
a first part that assigns serial addresses to all addresses of multiple disk drives of the disk array apparatus in an order of disk drive;
a second part that equally separates the serial addresses into a first disk group having first serial addresses in an increasing order and a second disk group having second serial addresses in the increasing order; and
a third part that writes data in the first disk group at one of the first serial addresses and in the second disk group at a corresponding one of the second serial addresses, said corresponding one of the second serial addresses being obtained by adding a maximum serial address out of the first serial addresses of the first disk group to said one of the first serial addresses.

6. The device as claimed in claim 5, wherein in a case where the disk array apparatus N disk drives (N is a natural number equal to or greater than 2) and a maximum address of each of the disk drives is L, the maximum serial address of the first disk group is now labeled Amax and is described as follows:
Amax=(N¥2)×L+(Nmod2)×(L/2)
where ¥2 denotes a quotient of integer division by 2, and mod2 denotes a remainder.

7. The device as claimed in claim 5, wherein the disk array apparatus has an odd number of disk drives as the multiple disk drives.

8. The device as claimed in claim 6, wherein the disk array apparatus has an odd number of disk drives as the multiple disk drives.
